(19) United States
(12) Patent Application Publication
(10) Pub. No.: US 2003/0218283 A1
(43) Pub. Date: Nov. 27, 2003

(54) Damped micromechanical device

(76) Inventors: Kevin Y. Yasumura, Danville, CA (US); John D. Grade, Mountain View, CA (US); John H. Jerman, Palo Alto, CA (US)

Correspondence Address: Edward N. Bachand, DORSEY & WHITNEY LLP, Intellectual Property Department, Four Embarcadero Center, Suite 3400, San Francisco, CA, 94111-4187, US

(21) Appl. No.: 10/360,986

(22) Filed: Feb. 8, 2003

Related U.S. Application Data
(60) Provisional application No. 60/355,145, filed on Feb. 8, 2002.

(51) Int. Cl. F16M 1/00

(52) U.S. Cl. 267/136; 188/378

(57) ABSTRACT

A damped micromechanical device useful for adjusting optical components, positioning transducers, and sensing motion. The micromechanical device includes a top cap that helps create an area of restricted fluid flow to increase mechanical damping of the device and minimize the response of the structure to mechanical perturbations. The micromechanical device is constructed to cause piston-like Poiseuille flow through controlled gaps within the actuator. By controlling the gap dimensions, the amount of damping can be adjusted.

### CROSS-REFERENCE TO RELATED APPLICATION

This application claims priority to U.S. provisional patent application No. 60/335,146 filed Feb. 8, 2002, the entire content of which is incorporated herein by this reference.

### SCOPE OF THE INVENTION

The present invention relates generally to micromechanical devices and more particularly to a mechanically-damped micromechanical actuator.

### BACKGROUND

Micromechanical devices such as microactuators are used for many purposes, including moving and adjusting optical components. Similar structures can be used as sensors for acceleration. An example of a linear microactuator, designed to translate a mirror in and out of a beam of light, is described in issued U.S. Pat. No. 5,998,906. In this design, the devices were activated against mechanical stops and were relatively immune from the effects of vibration. The mechanical dynamical behavior of micromechanical structures can be characterized as having an amplitude and phase response as a function of mechanical drive frequency, as displayed, for example, in a conventional Bode plot. Typically, for a micromechanical device, such mechanical response can be approximated as having a set of in-plane and out-of-plane resonances, each of which can be characterized as having a resonant frequency and a mechanical quality factor (“Q”). Since the damping of the sensor or actuator material itself is generally quite low, the overall damping is often dominated by the gas or liquid fluid environment surrounding the micromechanical structure.

Micromechanical devices are prone to the effects of externally-imposed mechanical vibration, in that any acceleration imposes a force on the moving mass of the device that tends to move the device an amount dependent on the suspension stiffness in the direction of the acceleration. Designs to minimize these effects are described in U.S. Pat. No. 6,469,415 and use counterbalancing masses to minimize motion of the moving structure of the device due to external accelerations applied to the device. These balanced designs tend to reduce the motion of high-Q mechanical resonances by minimizing the drive force acting on particularly the in-plane fundamental resonance of the device, but do little to reduce the effect of electrical drive excitation of that resonance or the mechanical response of other higher modes that may not be effectively balanced.

In the prior art, two general techniques have been used to damp micromechanical structures. One involves the parallel-plate motion of structures that produce “squeeze-film” damping, and the other is the lateral motion of a structure with respect to a fixed surface that generates shear forces from Couette flow in an intervening fluid and thus mechanical damping of that motion.

The effects of squeeze-film damping has been recently reported by E. -S. Kim, et. al., in a paper entitled “Effect of holes and edges on the squeeze film damping of perforated micromechanical structures.” (Proceedings of the 12th IEEE Int'l Conf. On Micro Electro Mechanical Systems (MEMS '99), at 296-301, January 1999.) Squeeze film damping has been conventionally used to damp bulk, micromachined accelerometers, for example as described in U.S. Pat. No. 5,445,006. The effects of lateral microstructure movement have been described by Y. -H. Cho et. al., in a paper entitled “Viscous energy dissipation in laterally oscillating planar microstructures: a theoretical and experimental study.” (Proceedings of the 3rd IEEE Int'l Conf. On Micro Electro Mechanical Systems, (MEMS '93), at 93-98, January 1993.) In this paper, lateral surface micromachined structures were analyzed and the Couette fluid flow and sheer forces calculated, particularly as they affect resonant microsensors, where high Q and low damping are generally preferred.

There is a need in the art for a micromechanical device exhibiting mechanical damping of vibrations within micromechanical structures, exceeding that of damping provided by squeeze-film and Couette damping.

### SUMMARY OF THE INVENTION

The present invention, in one embodiment, is a damped micromechanical device. The device includes a body having substantially parallel first and second walls at least partially defining an internal chamber. A fluid and a movable structure are disposed in the chamber. The movable structure is movable in a direction substantially parallel to the first and second walls. The body constrains the fluid in the chamber to flow between the movable structure and the first and second walls when the movable structure is in motion within the chamber so as to mechanically damp the movable structure. In one embodiment, the damped micromechanical device further includes a dashpot, which adds additional mechanical damping to the structure.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and description are to be regarded as illustrative in nature and not restrictive.

### BRIEF DESCRIPTION OF THE DRAWINGS

The accompanying drawings, which are somewhat schematic in many instances and are incorporated in and form a part of this specification, illustrate exemplary embodiments of the invention and, together with the description, serve to explain the principles of the invention

FIG. 1 is a plan view of a damped micromechanical device having a top cap to restrict fluid flow, according to one embodiment of the present invention.

FIG. 2 is a schematic sectional view of the damped micromechanical device of FIG. 1, taken along the line 2-2 shown in FIG. 1.

FIG. 3 is an enlarged, plan view of a dashpot of FIG. 1 enclosed with a dashed line in FIG. 1 and marked FIG. 3.

FIG. 4 is a schematic sectional view of the dashpot of FIG. 3, taken along the line 4-4 in FIG. 3.

### DESCRIPTION OF THE INVENTION

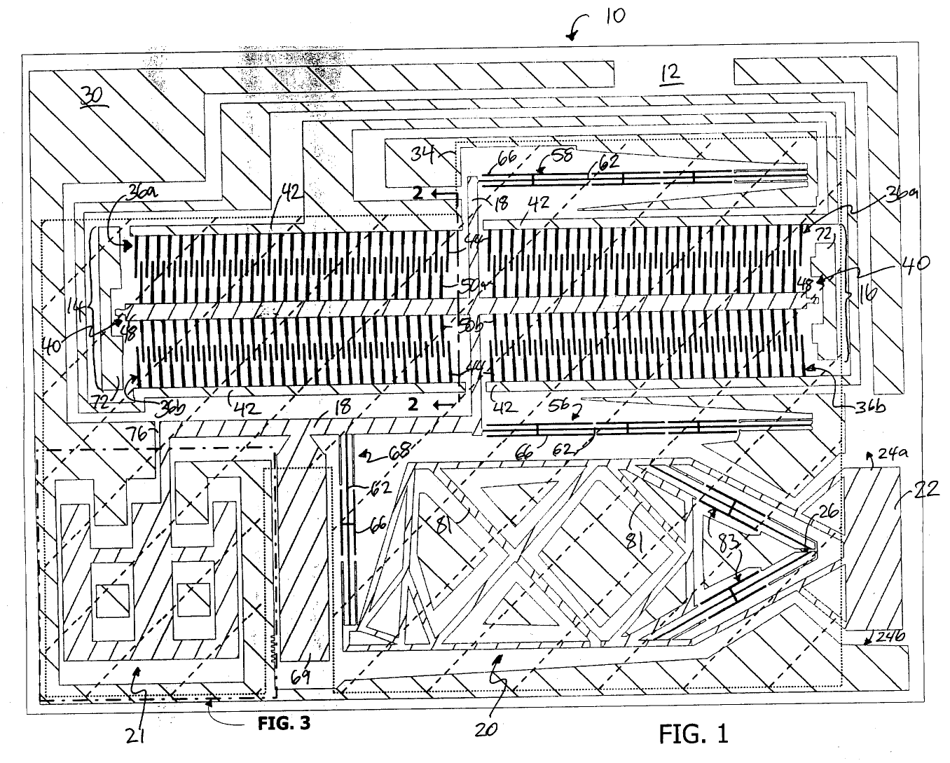

The damped micromechanical device 10 of the present invention can be an actuator that includes a base or planar substrate 12, first and second microactuators or motors 14 and 16, a shuttle 18, and a pivot assembly 20 (see FIG. 1). In one embodiment, the damped micromechanical device 10 further includes a dashpot 21 for damping vibration within the device 10. The microactuators 14 and 16 are coupled to the pivot assembly 20 via the substantially rigid shuttle 18, such that actuation of the microactuators 14 and 16 cause a corresponding rotation of the pivot assembly as further detailed below. The pivot assembly is connected to a movable platform 22, which moves in an arc 24a or 24b about a pivot point 26. A movable component is connected to the movable platform 22 and is articulated by actuation of the microactuators 14 and 16. In one embodiment, the movable component is a collimating lens for use in a telecommunications system.

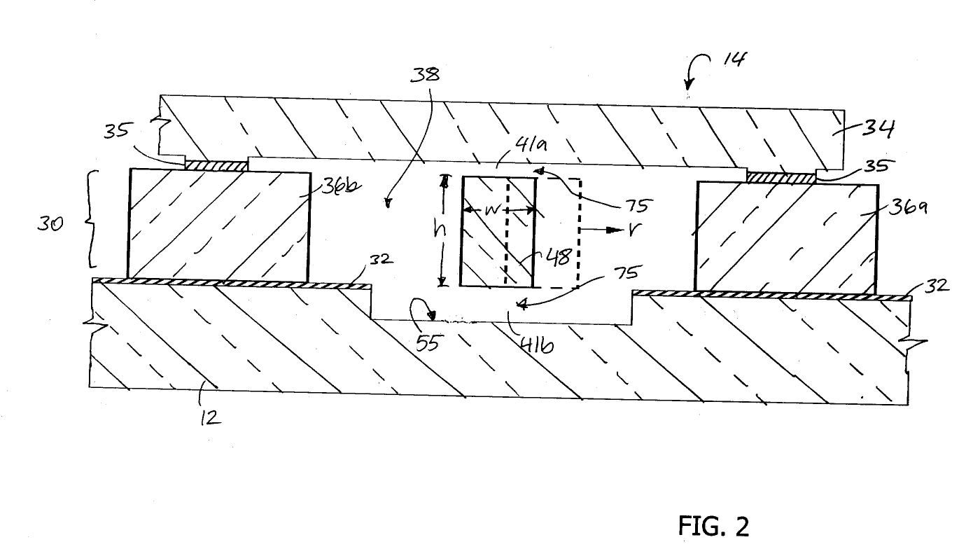

The damped micromechanical device 10, in one embodiment, is formed from the substrate 12 using an etching technique such as deep reactive ion etching. In another embodiment, the device 10 is formed using an electroplating technique, such as LIGA. The substrate 12 may be a silicon wafer and can have a thickness of between about 200 and 600 microns. In one embodiment, a second layer 30 is attached to the substrate 12 (see FIG. 2). The second layer 30 may be made from any suitable material, such as silicon, and is secured at certain points to the substrate 12 using any known technique. The second layer 30 may be fusion bonded to the substrate 12 using a silicon dioxide layer 32. The second layer 30 can have a thickness of between about 1 and 600 microns, preferably between about 10 and 150 microns, and more preferably about 85 microns. A top layer or top cap 34 (shown in FIG. 2 and by the dotted line in FIG. 1) overlies the second layer 30 and is secured at certain points using any known bonding technique, such as an adhesive or solder. An insulating layer 35 electrically insulates the top cap 34 from the second layer 30. The top cap 34 may be attached after completion of all etching of the second layer 30.

Each of the movable components of the damped micromechanical device 10 is formed from the second layer 30 overlying the substrate 12 using a suitable etching technique. These components, including the microactuators 14 and 16, the shuttle 18, and the pivot assembly 20, are then released from the substrate 12 to allow motion across the surface of the substrate 12 (see FIG. 1).

The first and second microactuators 14 and 16 can be of any suitable type known in the art, such as an electromagnetic or any other electrically-driven microactuator. In the embodiment shown in FIG. 1, the microactuators 14 and 16 are electrostatic microactuators. Although the microactuators 14 and 16 need not be identical, they are shown as substantially similar in construction and similar to microactuators disclosed in U.S. Pat. No. 6,384,510, the entire content of which is incorporated herein by this reference. Micromechanical structures similar in construction to microactuators 14 and 16 can also be used when the micromechanical device of the present invention is use for position sensing and in sensors such as accelerometers.

In one suitable embodiment, each of the microactuators 14 and 16 includes first and second stationary comb drive members 36a and 36b, which also serve as first and second sidewalls of an internal chamber 38 further defined by the substrate 12 and the top cap 34. The stationary comb drive members 36a and 36b are formed from the second layer 30, but remain secured to the substrate 12. A movable comb drive member 40 is disposed between the stationary members 36a and 36b and within the chamber 38. The movable member 40 is formed from the second layer 30 and released to allow movement of the movable member 40 with respect to the substrate 12.

The stationary members 36a and 36b are disposed generally parallel to each other and each include a longitudinally-extending stationary truss 42 and a plurality of stationary comb fingers 44 extending from the stationary truss 42 toward the movable member 40. The stationary comb fingers 44 are disposed at generally equally-spaced positions along the truss 42. The stationary comb fingers 44 are substantially similar in construction and can each have a length of between about 15 and 150 microns. The movable member 40 includes a longitudinally-extending movable structure or movable truss 48, a plurality of movable comb fingers 50a extending from the movable truss 48 toward the stationary member 36a, and a plurality of movable comb fingers 50b extending from the movable truss 48 toward the stationary member 36b. In the embodiment of FIG. 1, the microactuators 14 and 16 share the common movable truss 48, which is connected to the shuttle 18. In one embodiment, the movable truss 48 has a height, measured in a direction normal to the plane of substrate 12 of between about one and 200 microns, and preferably between about 10 and 150 microns. The height of the truss 48 is substantially equal to the height of the second layer 30 from which it is formed. In one embodiment, the comb fingers 44 and 50 are spaced apart from one another at a distance of between about 10 and 40 microns. The comb fingers 44 and 50 each have a height approximating the height of the corresponding truss 42 or 48 and a proximal portion with a width that is greater than the width of the corresponding distal portion of the comb finger.

As discussed above and shown in FIG. 2, the movable truss 48 of the movable member 40 is disposed within an internal chamber 38, which in one embodiment is defined by the stationary members 36a and 36b, the substrate 12 and the top cap 41. For simplicity, comb fingers 44, 50a, and 50b are not shown in FIG. 2. The movable truss 48 is spaced from the top cap 34 and from the substrate 12 leaving flow restricted regions in the form of a top gap 41a and a bottom gap 41b, respectively. In one embodiment, the top gap 41a and the bottom gap 41b are from about 0.5 to about fifteen microns each. In one embodiment, the top gap 41a is from one to about ten microns and the bottom gap 41b is from about 0.5 to about five microns. In the illustrated embodiment, a cavity or recess 55 is formed in the substrate 12 and opens onto the top surface of the substrate. This cavity 55 can serve to enlarge the size of the bottom gap 41b. The cavity 55 may be etched into the substrate 12 to a depth of between about 0.5 and five microns in a portion of the substrate located below the movable truss 48. In one embodiment where the gaps 41a and 41b are substantially equal, the height of the movable truss 48 is greater than one-third of the top gap 41a or the bottom gap 41b.

The shuttle 18, which couples the microactuators 14 and 16 to the pivot assembly 20, has a first portion that extends between the microactuators 14 and 16 at an approximately right angle to the movable truss 48. The shuttle 18 is coupled to the substrate by a first flexural member 56 and a second flexural member 58. The first and second flexural members 56 and 58 permit movement of the movable comb drive member relative to the substrate and provide the movable components of the damped micromechanical actuator with linear stiffness along a longitudinal axis of the microactuators 14 and 16. The flexural members 56 and 58 also bias the movable comb drive member 40 to a generally central location between the stationary comb drive members 36a and 36b. Although the flexural members 56 and 58 can have any suitable structure, in one embodiment each is formed from an elongate beam-like member or flexural beam 62 having a first end 62a coupled to the substrate 12 and a second end 62b connected to the shuttle 18. Thin, elongate sacrificial beams 66 are provided for each flexural beam 62 to facilitate etching of the flexural beam 62. A third flexural member 68 connects the shuttle 18 to the pivot assembly 20. The shuttle 18 further connects to the optional dashpot 21 and to an optional balancing mass platform 69.

The movable member 40 is movable over the substrate 12 relative to the stationary members 36a and 36b from an unactuated or home position, shown in FIG. 1, in which the comb fingers 44 and 50 are not substantially fully interdigitated, to a first actuated position located near the stationary member 36a, shown in FIG. 2 with respect to movable truss 48. Comb fingers 44 and 50a are substantially fully interdigitated when the movable member is in the first actuated position. The movable member 40 is also movable in an opposite direction to a second actuated position located near the stationary member 36b, in which the comb fingers 44 and 50b are substantially fully interdigitated. The comb fingers 44 and 50 are shown in FIG. 1 as partially interdigitated in their home position. Although the comb fingers 44 and 50 are shown as being partially interdigitated when the movable member 40 is in the home position, the comb fingers 44 and 50 can be fully disengaged when the movable member 40 is in the home position and be within the scope of the present invention. As used herein, substantially fully interdigitated includes any position in which the comb fingers 44 and 50 are more interdigitated than in the home position. When actuated to the first position, the comb fingers 50a extend between the comb fingers 44 and approach but do not contact the stationary truss 42. As discussed above, FIG. 2 is a schematic sectional view of the first microactuator 14 in which the components are not illustrated to scale and the comb fingers 44 and 50a are not shown.

The range of motion of the movable member 40 is limited by a stop 72 formed from the second layer 30. In one embodiment, the range of motion of the movable member 40, between the first actuated position and the second actuated position, is between about 1 and 200 microns and preferably between about 10 and 100 microns.

The stationary and movable comb fingers 44 and 50, in one embodiment, are of the type disclosed in U.S. Pat. No. 6,384,510, referenced above. In this embodiment, the comb fingers 44 and 50 are slightly inclined from a line extending normal to the respective truss 42 and 48. Furthermore, when the movable member 40 is in the home position, the comb fingers 50 are offset from a midpoint line extending between adjacent pairs of comb fingers 44. When the movable member 40 moves to a fully interdigitated position, the comb fingers 50 become substantially centered between adjacent pairs of comb fingers 44. This inclination and offset account for the shortening of the flexural members 56 and 58 during actuation.

The pivot assembly 20 includes a pivot member or lever 81, which includes the platform 22, and the first and second flexure members 83 for coupling the pivot member to the substrate 12. The flexure members 83 are similar in construction to the flexure member 56 and 58 described above.

During operation of the micromechanical device 10, the first and second microactuators 14 and 16 are actuated by supplying an oppositely-charged electric potential to the stationary and movable comb drive members 36 and 40, using techniques known in the art. The extent and direction of movement of the movable member 40 is determined in part by the magnitude of voltage potential across the comb fingers 44 and 50. Movement of the movable truss 48 of the movable member 40 causes a corresponding substantially linear movement of the shuttle 18, in a direction generally perpendicular to the elongate movable truss 48. The movement of the shuttle 18 causes the transfer of a force to the pivot assembly 20 through the third flexural member 68. This force causes the pivot assembly 20 to rotate in one of opposite first and second directions about the pivot point 26. Such rotation of the pivot assembly 20 causes the movable platform 22 to move in one of substantially opposite first and second directions as shown by arrows 24a and 24b. This motion of the movable platform 22 causes motion of the movable component coupled to the platform.

A suitable damping fluid such as air is disposed in the chamber 38 (see FIG. 2). Motion of the movable member 40 displaces the fluid 75, which is restricted by the structures surrounding the chamber 38 from escaping device 10 (see FIG. 2). The top cap 34 covers a large fraction of the surface area of the micromechanical device 10 producing a number of flow-restricted regions, such as gaps 41a, within the microactuators 14 and 16. In these flow-restricted regions, the reduction in the cross-sectional area of the fluid passageway causes an increase in the fluid flow rate in these regions. Thus, as the movable member 40 moves, air is forced through these regions at relatively high fluid flow rates.

The pressure-driven flow through the flow-restricted regions creates a damping force on the moving surfaces adjoining such regions. For example, when member 40 moves as a result of an external force applied to the device 10, damping forces are exerted on the movable truss 48 by the pressure-driven Poiseuille flow through the top gap 41a, the bottom gap 41b, or both, which results in a mechanical dissipation or damping of such external forces. Further damping within the microactuators 14 and 16 is caused by the Couette flow of the fluid in the chamber 38 between adjacent comb fingers 44 and 50.

The cap 34 constrains the fluid 75 within chamber 38 to flow through the flow-restricted regions 76 during movement of the movable member 40. As the movable member 40 oscillates or moves in the lateral direction, as shown by the arrow in FIG. 2, a volume of fluid such as air proportional to the height h of the movable truss 48 and width w perpendicular to the direction of motion is displaced. If the device 10 were not capped, as in prior art devices, this displaced air would be free to leave the chamber 38 by flowing upwards and away from the movable truss 48. In that case, the only appreciable damping would be due to the shear, or Couette, flow in cavity 38. In the present invention, however, the cap 34 constrains the displaced fluid 75 to travel through the restrictive gaps 41a and 41b and other flow-restricted regions 76, substantially increasing the dissipation or damping of vibrations within the movable components of the device 10.

The magnitude of the Couette and Poiseuille damping can be directly compared in a simplified case, exemplified by a device with a cross-section similar to that shown in FIG. 2, where the pressure driven flow and shear flow are both generated by the same moving element, namely movable truss 48. In this example, the moving element with velocity ν generates a shear flow due to that motion and generates a pressure driven flow due to that same motion. For the simplified two-dimensional case, the Couette shear force, τ_{c}, can be approximated by:

τ_{c}=μν/g

where μ is the fluid viscosity and ν is the velocity of the moving plate. A similar damping term is created for both the top gap 41a and bottom gap 41b, so the total Couette shear force for configuration shown in FIG. 1 is:

τ_{c}=μν/g₁+μν/g₂=μν(g₁+g₂)/g₁g₂

where g₁ and g₂ correspond to the top gap 41a and the bottom gap 41b. For a movable truss 48 with the height “h,” the Poiseuille damping force can be approximated by:

τₚ=μν 6h(g₁+g₂)/(g₁³+g₂³)

As can be seen, both Couette and Poiseuille damping terms are functions of the same fluid viscosity and plate velocity. In one embodiment, it is desirable for the Poiseuille damping to exceed the Couette damping. For the case where the top gap 41a is substantially equal to the bottom gap 41b, the Poiseuille damping exceeds the Couette damping when h is greater than one-third the gap 41a or 41b. Thus, for the capped, laterally-moving micromechanical actuator of the present invention, the Poiseuille damping dominates over Couette damping. For embodiments having relatively large heights and small gaps, this large Poiseuille damping can reduce the Q of the lateral resonant modes of the device to values between 0.5 and 10. This represents a substantial reduction over devices in which only Couette damping is present, which typically have Q values from about 10 to about 100.

Where the top gap 41a and bottom gap 41b are not equal, the original equations can be used. For a movable truss 48 with a top gap 41a of 5 microns, a bottom gap 41b of 15 microns, and a height h of 85 microns, the Poiseuille flow condition would produce a damping force approximately 12 times larger than the Couette flow condition, and the Q of the lateral mode providing that motion would be reduced by the same factor. If the larger gap is taken to be a factor of n times the smaller gap g, then the Poiseuille damping dominates when h is greater than about n² g/6.

In one embodiment of the present invention, for example, experimentally measured Q values have been obtained for uncapped and capped configurations. With a bottom gap 41b measured to be approximately 5 microns and a height measured to be about 83 microns, the Q of the moving components of the device 10 was measured to be about 41 without a top cap. In the same device including a cap 34 defining a top gap 41a of about 5 microns, the Q was measured to be about 2.4.

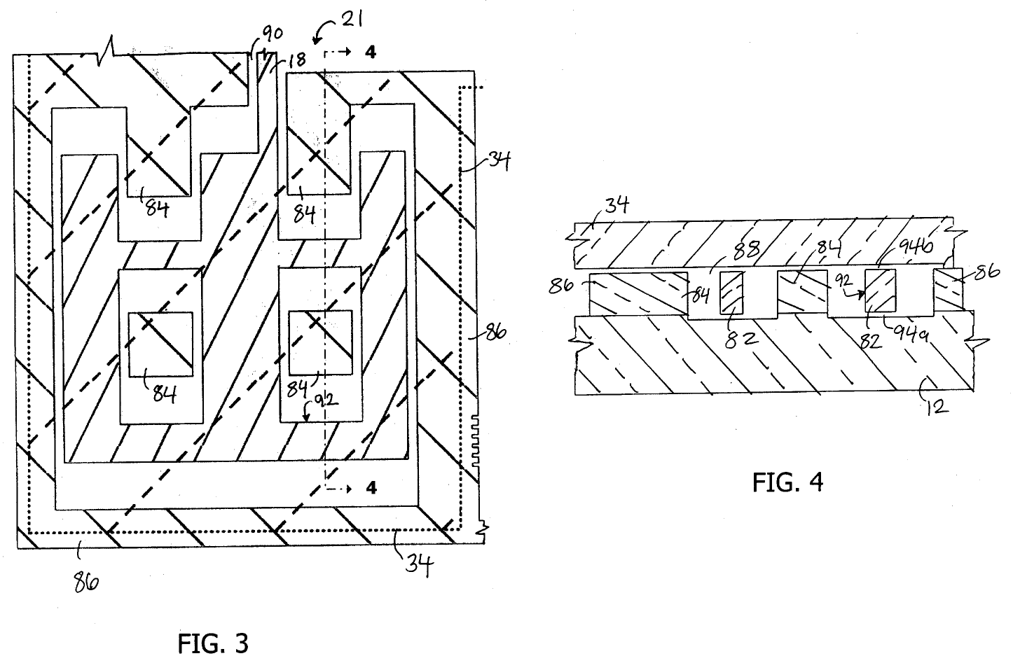

One embodiment of the present invention includes optional dashpot 21 coupled to the shuttle 18. The dashpot 21 acts to provide further mechanical damping to the moving portions of the micromechanical device 10 by, among other things, providing a plurality of additional flow-restricted regions 76 to the device 10. The dashpot 21 is formed from the second layer 30 overlying the substrate 12 and includes both a movable structure 82 and fixed posts 84 (see FIGS. 3 and 4). The movable structure 82 and fixed posts 84 are surrounded by the substrate 12, the top cap 32, and a side wall 86. These components form a dashpot chamber 88 holding fluid 75. The fluid can enter or exit the dashpot chamber 88 through a restricted-flow region, such as a flow channel 90, or any other suitable channel. By enclosing the dashpot from below, on the sides, and above, a region of high damping capacity is created by again creating pressure-driven or Poiseuille flow in the flow-restricted regions created for example by the closely spaced-apart surfaces of the movable structure 82 and the fixed posts 84.

In this embodiment, actuation of the microactuators 14 and 16 causes a corresponding lateral translation of the movable structure 84, which is attached to the shuttle 18. As the movable structure 84 translates from an initial home position (shown in FIGS. 3 and 4) to an actuated position in which a leading surface 92 approaches the fixed post 84, the fluid within the dashpot chamber 88 is forced to flow through the various flow-restricted regions 76 within the dashpot. For example, desirable Poiseuille flow is created in a top gap 94a between the movable structure 82 and the top cap 34 and a bottom gap 94b between the movable structure 82 and the substrate 12. These gaps 94a and 94b are each flow-restricted regions. Such fluid flow creates a damping force on the movable structure 82, as described above, which mechanically damps vibrations within the movable structure 82, as well as the shuttle 18 and the movable portion of the microactuators 14 and 16.

This dashpot 21 can also function to damp out-of-plane vibrations due to the squeeze-film damping between the plate regions of the top and bottom of these structures and the top cap 34 and substrate 12. In one embodiment, the total damping is increased by increasing the combined top and bottom surface area of those portions of the movable structure 82 over which fluid flows. In this embodiment, the overall damping of the movable components of the micromechanical device 10 is a summation of the damping action within the microactuators 14 and 16 and the damping action of the dashpot 21.

While the movable component has been described as an optical element such as an optical lens, a skilled artisan will appreciate that any other element can be carried by the holder and thus the damped micromechanical actuator. Other optical elements that are suitable as movable components include optical filters, prisms, and attenuators. In addition, the damped micromechanical actuator or device 10 of the present invention can also function to position transducing heads in data storage devices, transducer element, and motion sensing elements, including lateral accelerometers. The damping techniques of the present invention can also be applied to a micromechanical device having two degrees of motion. One example of such a device is provided in co-pending U.S. patent application Ser. No. 09/938,871 filed Aug. 24, 2001, the entire content of which is incorporated herein by this reference.

Although the present invention has been described with reference to exemplary embodiments, persons skilled in the art will recognize that changes may be made in form and detail without departing from the spirit and scope of the invention.

We claim:

1. A damped micromechanical device comprising a body having substantially parallel first and second walls at least partially defining an internal chamber, a fluid disposed in the chamber and a movable structure disposed in the chamber and movable in a direction substantially parallel to the first and second walls, the body constraining the fluid in the chamber to flow between the movable structure and the first and second walls when the movable structure is in motion within the chamber so as to mechanically damp the movable structure.

2. The micromechanical device of claim 1 wherein the body includes a main body portion provided with a recess and including the first wall and a cap overlying the recess and including the second wall.

3. The micromechanical device of claim 1 wherein the movable structure has a height h and the movable structure is spaced from the first wall by a first gap g₁ and is spaced from the second wall by a second gap g₂, the values of h, g₁ and g₂ being chosen so that the Poiseuille damping force between the movable structure and the first and second walls is greater than the Couette damping force between the movable structure and the first and second walls.

4. The micromechanical device of claim 3 wherein the Poiseuille damping force is defined by the equation:
τₚ=μν6h(g₁+g₂)/(g₁³+g₂³)
where μ is the viscosity of the fluid and ν is the velocity of the movable structure when in motion and wherein the Couette damping force is defined by the equation:
τ_{c}=μν/g₁+μν/g₂.

5. The micromechanical device of claim 1 wherein the movable structure is a micromachined movable structure.

6. The micromechanical device of claim 3 wherein the first gap g₁ ranges from about ½ to about fifteen microns.

7. The micromechanical device of claim 6 wherein the first gap g₁ is approximately five microns.

8. The micromechanical device of claim 3 wherein the second gap g₂ ranges from about ½ to about fifteen microns.

9. The micromechanical device of claim 8 wherein the second gap g₂ ranges from about five to about fifteen microns.

10. A microactuator device for moving an optical component in a tunable laser, the device comprising:
a body having a base and generally opposed first and second side walls;
a movable comb drive member disposed between the first and second side walls, the movable member spaced from the base by a bottom gap; and
a top cap overlying the first and second side walls and having a lower surface, the top cap defining a top gap between the lower surface and the movable member;
wherein the body and the top cap at least partially define an internal chamber, the internal chamber holding a fluid; and
further wherein translation of the movable member between a first position nearer the first wall and a second position nearer the second wall causes Poiseuille flow of fluid through the top gap and the bottom gap.

11. The device of claim 10 wherein during operation the microactuator has a mechanical quality Q of between about 0.5 and about ten.

12. The device of claim 10 wherein the movable member has a lower edge and wherein the base defines a cavity extending a portion of a distance between the first and second side walls, wherein the cavity has a bottom surface that is spaced from between about five and about fifteen microns from the lower edge.

13. The device of claim 10 wherein the top gap and the bottom gap are substantially equal and the movable member has a height that is greater than one third of the top gap.

14. The device of claim 10 wherein the top gap is from about ½ to about fifteen microns.

15. The device of claim 14 wherein the top gap is about five microns.

16. The device of claim 15 wherein the bottom gap is from about ½ to about fifteen microns.

17. The device of claim 10 wherein the base further includes generally opposed first and second end walls disposed substantially perpendicular to the first and second side walls and wherein the movable member is spaced from the end walls by a side gap.

18. The device of claim 17 wherein the side gap is from about two to about ten microns and further wherein translation of the movable member between the first position and the second position causes Poiseuille flow of fluid through the side gap.

19. The device of claim 10 further including a dashpot device in fluid communication with the internal chamber, the dashpot device including at least one Couette damping surface and at least one Poiseuille damping surface.
